(19) United States
(12) Patent Application Publication
(10) Pub. No.: US 2003/0223648 A1
(43) Pub. Date: Dec. 4, 2003

(54) Method of correcting image shift

(76) Inventors: Richard E. Albrecht, Chapel Hill, NC (US); Gary Pedeville, Duvall, WA (US); Ronald F. Rykowski, Woodinville, WA (US); C. Benjamin Wooley, Chapel Hill, NC (US)

Correspondence Address: Kit M. Stetina, Esq., STETINA BRUNDA GARRED & BRUCKER, 75 Enterprise, Suite 250, Aliso Viejo, CA, 92656, US

(21) Appl. No.: 10/157,176

(22) Filed: May 29, 2002

(51) Int. Cl. G06K 9/32

(52) U.S. Cl. 382/294

(57) ABSTRACT

A method of correcting image shift and magnification differences of multiple images which are used to create a single measurement of an imaging light and color measurement device. The multiple images are taken from a test object utilizing the imaging light and color measurement device through different optical paths. Software is utilized to shift the pixels vertically and/or horizontally with a shift fraction determined based on the magnitude of the image shift in a direction opposing to the shift. Software is uses to further move the pixels inwardly or outwardly with a pixel value determined on the magnification differential of images.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to a method of correcting image shift for images or measurements made using a detector array such as a charge-coupled device (CCD). More particularly, the present invention relates to a method of correcting image shift caused by incorporating multiple CCD images into one single light and/or color measurement made by an imaging light and color measurement system.

Charge-coupled devices (CCD) have been broadly applied in scanners and digital cameras to quantifiably measure luminance, illuminance and color coordinates of light sources or any illuminated object. Currently, various structures for measuring a color of a light source or an object have been applied to the charge-coupled device. The resultant device is often referred to as an imaging light and color measurement system. The imaging light and color measurement system comprises a lens which images light onto an array of detectors (e.g., pixels of a CCD), and optical elements designed to modify the spectral power distribution of the light incident on the array of detectors (optionally designed to allow the spectral response of the system to match a specific color space). In order to measure light and color using an imaging light and color measurement system, one or more instances of irradiation of the same CCD may be used for one measurement, or one or more irradiation of multiple CCD's may be used for one measurement. Each of the instances of irradiation of the CCD('s) creates images of the source or object being measured. For example, in a single three-color charge-coupled device, blue, red and green color dies are directly mounted on pixels of the charge-coupled device. The blue, red and green images obtained from adjacent pixels are then merged to display the color of the object or the light source. For measurements made with this type of CCD, three images are created, but only one instance of irradiation of the CCD is used. In another structure, a beam splitting prism is used to split an incoming light into three wavelength bands. The light beams in the three wavelength bands are then imaged onto three separate charge-coupled devices. In this example, three images are created by one instance of irradiation of multiple CCD's. In an alternative structure, two or more color filters are used and sequentially moved in front of a single charge-coupled device for producing a color image. In this example, multiple instances of irradiation of the same CCD are made to produce multiple images which are then used together for a single measurement.

The color measurements which use multiple images have the advantage that the optical elements designed to modify the spectral power distribution of the light incident on the array of detectors can be made to more closely match a desired spectrum, such as the CIE responsivity curves. Further, for system utilizing a sequential movement of the color filters in front of the detector array, independent exposure settings are allowed for each color band.

However, one problem for using multiple images through different optical paths to create a single measurement is that it is difficult to ensure that the different images are all perfectly overlayed on top of each other to form the final image for the measurement. That is, the images comprising the single color measurement can be shifted, out of focus, or magnified relative to each other. For the example of an imaging light and color measurement system incorporating two of more color filters and single charge-coupled device, light passing through the color filters is deflected if two opposing surface planes, that is, the light entrance and exit planes, of the color filters are not perfectly parallel to each other. The optical axis of the light incident onto the charge-coupled device is thus deviated to produce an image shift. The image shift varies in magnitude and direction for each filter which causes an undesirable misalignment of the images on the charge-coupled device.

For the example of the light and color measurement system incorporating multiple color filters and a single CCD, another source of image misalignment is caused by using filters made of materials that have different refractive indices. It is very often that the absorptive filters are made of different types of absorbing material such as glass or plastic. The different refractive indices can cause different optical path lengths for images taken with each color filter. Consequently, the ideal focus for each image can be at different positions. If the lens is adjusted to the best focus for one filter, the image may be out of focus for other filters.

It is therefore a need to provide a method for correcting image shift and variable image magnification caused by using multiple images through different optical paths to create a single measurement.

### BRIEF SUMMARY OF THE INVENTION

The present invention provides a method of correcting misalignment, focus differences, and magnification differences of images when multiple images that proceed through different optical paths are used to create a single measurement of an imaging light and color measurement device. When manufacturing the light and color measurement system, the optics are designed and mounted in such a way to minimize misalignment, focus differences and magnification differences of each image. The light and color measurement device is then used to take a measurement utilizing multiple images of a test object which is designed to easily show image shift and magnification. The image shift is corrected by utilizing software to shift each of the direction opposite to the individual image shift.

One image remains unchanged while pixels are shifted for all other images taken in a single color measurement until all of the individual images are aligned to the unchanged image. If the amount of shift required is a fraction of a pixel, then the pixel values can be calculated by interpolating values of four nearest surrounding pixels of a particular pixel.

The invention further provides a method of correcting an image magnification. By comparing the individual images obtained from the measurement of the test object, the magnification differential of each image is determined. One image remains unchanged while pixels other than a center pixel that captures an image from a center of the object are then shifted according to the magnification differential until all the individual images are aligned to the unchanged image.

In the above method, each of the pixels other than the center pixel is shifted by a pixel value equal to a multiplication of the magnification differential and a difference between said each of the pixel and the center pixel. The pixels are shifted inwardly with respect to the center pixel to correct an image that has been magnified, and shifted outwardly with respect to the center pixel to correct an image that has been minified.

In addition, effects caused by using different optical paths when multiple images that proceed through different optical paths are used to create a single measurement can be resolved by adjusting physical thickness of the optics and filters in each path until a unique effective optical thickness is obtained.

### BRIEF DESCRIPTION OF THE DRAWINGS

These, as well as other features of the present invention, will become more apparent upon reference to the drawings wherein:

FIG. 1(a) shows light rays traveling through a filter with parallel entrance and exit surface planes;

FIG. 1(b) shows light rays traveling through a tipped filter;

FIG. 1(c) shows light rays traveling through a wedged filter;

FIG. 2 shows a flow chart of the method for correcting the image shift;

FIG. 3 shows a flow chart of the method for correcting the image magnification; and

FIG. 4 shows a flow chart for using both the image shift correction software and the image magnification correction software to obtain a measurement of an object.

### DETAILED DESCRIPTION OF THE INVENTION

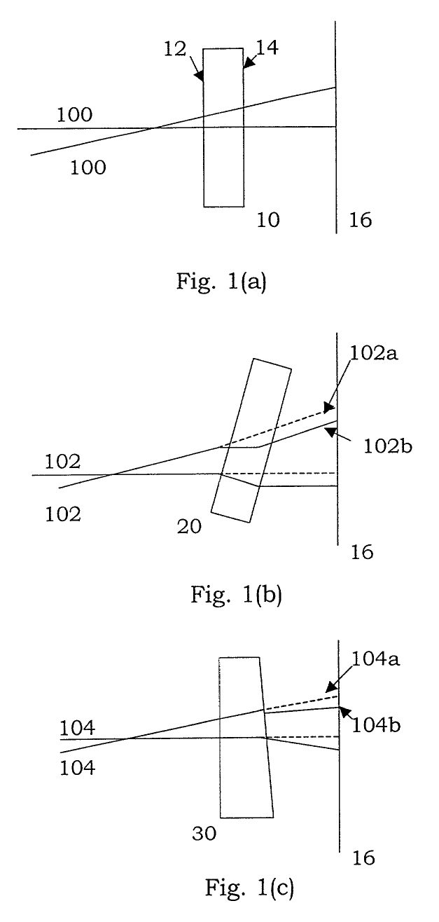

The present invention provides a method for correcting image shift (image shift caused by different optical path) and differential image magnification of a color image captured by a detector array such as a charge-coupled device when multiple images that proceed through different optical paths are used to create a single measurement of an imaging light and color measurement device. As an example, one embodiment of an imaging light and color measurement device utilizes a single charge coupled device and a set of filters each of which are mechanically moved in front of the CCD for different images in order to create one color measurement. In this example, iamge shift is caused by unparallel opposing surface planes of the filters, and differential image magnification is caused by using filters made of different materials. FIGS. 1(a) to 1(c) show light rays traveling through a filter with parallel entrance and exit surfaces, the filter disposed in a tipped position, and a filter having a wedge structure, respectively. As shown in FIG. 1(a), the light rays 100 traveling through a filter 10 with parallel entrance and exit planes 12 and 14 are incident on a charge-coupled device 16 with the ideal optical paths. In FIGS. 1(b) and 1(c), optical paths of the light rays 102 and 104 traveling through tipped filter 20 and the wedged filter 30 are deviated from the ideal optical paths 102a and 104a. The ideal optical paths 102a and 104a are illustrated in dash lines in FIGS. 1(b) and 1(c), while the deviated actual optical paths 102b and 104b being refracted by the filters 20 and 30 are illustrated in solid lines. Such deviation causes the image captured by the charge-coupled device shifted to be shifted away from the original position. It is appreciated that similar optical path differences as illustrated in FIGS. 1(b) and 1(c) caused by other optical designs may also occur to other embodiments of light and color measurement system.

While manufacturing the light and color measurement system, the optics thereof are designed in such a way to minimize misalignment, focus differences, and magnification differences of each image captured thereby. However, this cannot perfectly compensate the image shift, and an additional correction process is required.

Fine adjustment on the images to more completely remove the relative shift can be accomplished by software that processes each image separately. The light and color measurement device is used to take a measurement utilizing multiple images of a test object which is designed to easily show image shift and magnification. For example, multiple images of the test object are taken by the light and color measurement device having different optical paths, such as using different filters or other optics. One of the multiple images taken in the single measurement is chosen to remain unchanged or fixed; and consequently, the pixels comprising the chosen image remain at the same position as a reference. Meanwhile, for all other images, the pixels are shifted until all of the individual images are aligned with the fixed image. The corresponding shift amount for the pixels for each image is thus obtained. In the software, the pixels are moved horizontally or vertically along the direction opposite to the filter induced shift, thus negating the effect of the filter. The amount of shift required in each direction may also be some fraction amount of pixels. For example, an unadjusted image contains a row of pixels with values of 100, 150, 175, 250 and 300 in pixel locations 1, 2, 3, 4, and 5, respectively. If, due to differences in optical path (e.g., filter wedge), the image had been shifted by one pixel to the left relative to the chosen fixed image, such image shift can be corrected by shifting pixels to the right by one pixel. Alternatively, had the image been shifted to the right by one half of a pixel due to optical path differences, the pixel values need to be shifted to the left by one-half pixel, and the new pixel values would be 125, 163, 213, 275, 300 in pixel locations 1, 2, 3, 4 and 5, respectively. Assuming that an image is shifted to the left by a shift fraction Sf, R0 to Rn rows of pixels are shifted to the right by the shift fraction Sf as R0′ to Rn′ as:

R0′=R0

Rn′=Rn−(Rn−Rn−1)*Sf, where n>0

In the above example, the rows of pixels R0 to Rn are shifted as R0′ to Rn′ as follows to compensate the image shift.

R0′=100

R1′=R1−(R1−R0)*1=150−(150−100)*1=100

R2′=R2−(R2−R1)*1=175−(175−150)*1=150

R3′=R3−(R3−R2)*1=250−(250−175)*1=175

R4′=R4−(R4−R3)*1=300−(300−250)*1=250

If the image is shifted to the left by a shift fraction Sf equal to 0.2 pixels, the rows of pixels R0 to Rn are shifted to the right as:

R0′=100

R1′=150−(150−100)*0.2=140

R2′=175−(175−150)*0.2=170

R3′=250−(250−175)*0.2=235

R4′=300−(300−250)*0.2=290

When an image is shifted to the right by a shift fraction Sf, the rows of pixels R0 to Rn are thus shifted to the left by such shift fraction Sf as:

Rn′=Rn

Rn−1′=Rn−1+(Rn−Rn−1)*Sf, n>1

In the above example,

R4′=R4=300

R3′=R3+(R4−R3)*0.5=250+(300−250)*0.5=275

R2′=R2+(R3−R2)*0.5=175+(250−175)*0.5=212.5

R1′=R1+(R2−R1)*0.5=150+(175−150)*0.5=162.5

R0′=R0+(R1−R0)*0.5=100+(150−100)*0.5=125

The above introduces how to compensate the image shift along the horizontal direction. The image shift along the vertical direction can be compensated using similar calculation. That is, by interpolating the values of the nearest pixels in a column, the pixels are shifted vertically to compensate the vertical image shift. The present invention provides a method to correct image shift, in which the pixel value for each pixel are calculated by bi-linearly interpolating between the surrounding four pixels both horizontally and vertical.

As mentioned above, in addition to the image shift effect, the images can further be misaligned from each other if the optical path length for each image is different. For the example of the embodiment of the imaging light and color measurement which utilizes multiple filters and one CCD, this can be caused by filters with slightly different thickness or filters with glasses of slightly different index of refraction.

The variations in optical path length for each image can be corrected mechanically, in the above example, by slightly changing the physical thickness of each of the filters to achieve the same effective optical thickness (index of refraction times thickness). This can generally be accomplished without a significant effect on the spectral transmission properties. However, even the images may be focused at the same distance once the effective optical thickness matches, the resulting images may have different sizes due to the different magnification for different optical paths.

The present invention provides another software algorithm to correct the differential image magnification caused by different optics in different optical paths for each image in a single color measurement. As with the image shift, adjustments on the images to remove the differential magnification can be accomplished by software that processes each image separately. In the software, the raw image captured by each pixel of the charge-coupled device is compensated by continuously increasing or decreasing the value of the pixel from a center of the raw image to an edge thereof. The increment for shifting the pixels is determined by the magnification ratio between various images.

As with the image shift correction, the light and color measurement device is used to take a measurement utilizing multiple images of a test object which is designed to easily show image shift and magnification. One of the multiple images required for one measurement is chosen to remain unchanged or fixed; and consequently, the pixels comprising the fixed image are fixed. Meanwhile, for other images, the pixels are shifted with the fixed pixels as a reference until each of these other images is aligned with the unchanged image. For example, assuming that in a single color measurement, a first image, image A, is taken from an object via a first optical path of the imaging light and color measurement device. The image A captured by the charge-coupled device of the imaging light and color measurement device has a first image size. A second image B is taken from the object via a second optical path of the imaging light and color measurement device, and the second image taken by the charge-coupled device has a second size. The second size is 10% larger than the first size. While taking the images A and B of the object, the center of the object is aligned with the center of the charge-coupled device. Therefore, light originating from locations other than the center of the object are imaged at different pixel locations of the charge-coupled device for both the images A and B. In the case that image A is chosen as the reference image to remain fixed, when then image shift between the images A and B is zero or has been corrected, the pixel locations for the image B can be calculated based on the pixel locations for the image A as:

PixelRowB=PixelRowA+(PixelRowA−CenterPixelRow)*Mag

PixelColB=PixelColA+(PixelColA−CenterPixelCol)*Mag

where PixelRowA and PixelRowB are the index values of rows of pixels for taking the images A and B, respectively, while the CenterPixelRow is the value of row of pixel for the center of the object, and Mag is the magnification differential. Similarly, PixelColA and PixelColB are the index values of columns of pixels for taking the images A and B, respectively, while the CenterPixelCol is the value of the column of pixel for center of the object. For example, if the charge-coupled device has 1000 columns and 1000 rows of pixels and the magnification is 1.1 for the image B with respect to the image A, CenterPixelRow is 500, and CenterPixelCol is 500 too. If a light originating from an object point passing through the optical path for the image A is imaged at PixelRowA=300 and PixelColA=900, PixelRowB and PixelColB for the image B can be calculated as:

PixelRowB=200+(300−500)*0.1=180

PixelColB=900+(900−500)*0.1=940

This process is repeated for all pixels of the image B. Therefore, the value of gray level (light intensity) of pixel locations at Row 180 and Column 940 are moved to Row 200 and Column 940 for the image B, and an image produced by the optical path for the image B has a same size as that produced by the optical path for the image A.

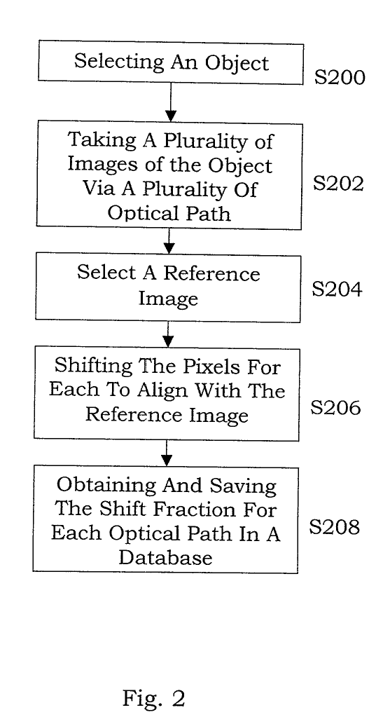

FIG. 2 shows a flow chart of the method for correcting the image shift. In step S200, an object designed to easily show image shift is selected. In step S202, a plurality of images are taken from the object via a plurality of optical paths of an imaging light and color measurement device. In step S204, one of the images is selected to remain unchanged; and consequently, the pixels corresponding to the image is fixed. In step S206, the pixels capturing each of the images other than the selected unchanged one are shifted until the image is aligned with the selected unchanged image. In step S208, a shift fraction with a specific shift direction is obtained for each optical path of the imaging light and color measurement device according to the shift of the pixels for the corresponding image. The shift fractions are then saved in a database.

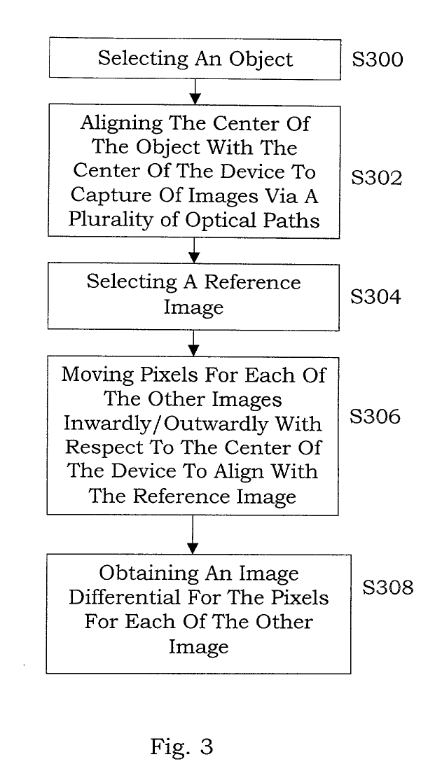

FIG. 3 shows a process flow of the method of image magnification correction. In step S300, an object designed to easily show image magnification is selected. In step S302, a plurality of images of the object for a plurality of Optical Paths are captured by aligning the center of the object with a center of an image extraction device of the imaging light and color measurement device. In step S304, one of the images is selected remain unchanged as a reference; and consequently, the pixels taking this selected image are also fixed. In step S306, the pixels for each of the other images is moved inwardly or outwardly with respect to the center of the charge-coupled device until the image is aligned with the reference image, depending whether the image is magnified or minified. In step S308, a magnification differential is obtained for each optical path of the imaging light and color measurement device and saved in a database.

In both the image shift and image magnification correction processes, the images captured by the charge-coupled device are input to a computer as the raw images. The software for compensating image shift and correcting image magnification are then called up to perform the correction on the raw images.

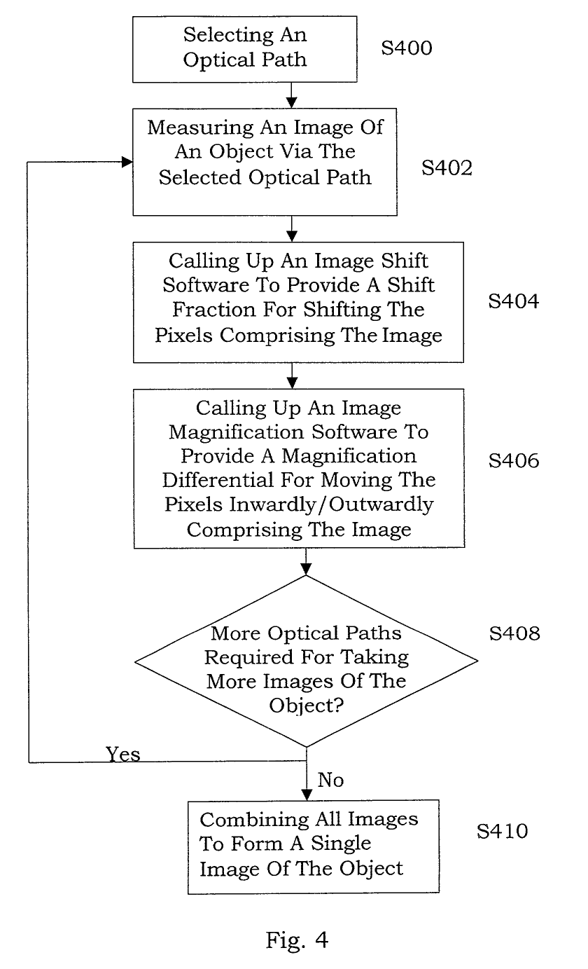

FIG. 4 shows a flow chart showing the steps for using both the image shift correction software and image magnification correction software to obtain a measurement of an object. In step S400, an optical path of an imaging light and color measurement device is selected for measuring an object. In step S402, an image is obtained by measuring the object via the selected optical path. In step S404, a software for image shift correction is called up, which provides a shift fraction with a specific shift direction for a plurality of pixels corresponding to the image. The pixels are thus shifted with the shift fraction along the specific shift direction. After the image shift correction is performed, in step S406, a software for image magnification correction is called up, which provides a magnification differential corresponding to the image, such that the pixels are moved according to the magnification differential. In step S408, after the image of the selected optical path is corrected, it is determined whether any more optical paths are required to capture more images. If an additional optical path is required, then the process goes back to step S402; if not, the correction is complete. In step S410, after the correction, all the images are combined to obtain a complete single image of the object.

Indeed, each of the features and embodiments described herein can be used by itself, or in combination with one or more of other features and embodiment. Thus, the invention is not limited by the illustrated embodiment but is to be defined by the following claims when read in the broadest reasonable manner to preserve the validity of the claims.

What is claimed is:

1. A method of correcting image shift, comprising:
capturing a plurality of images of a test object via a plurality of optical paths of a device, wherein the images are captured by a plurality of pixels of the device;
selecting one of the images as a reference image, and the pixels taking the reference image are fixed in position;
shifting the pixels comprising each of the other images until each image is aligned with the reference image.

2. The method according to claim 1, further comprising obtaining a shift fraction of the pixels for each image.

3. The method according to claim 2, further comprising obtaining the shift fraction of the pixels for each image from the shift between the image and the reference image.

4. The method according to claim 2, further comprising obtaining the shift fraction for each pixel of each image by interpolating values of a plurality of nearest pixels thereof.

5. The method according to claim 2, further comprising obtaining the shift fraction for each pixel of each image by interpolating values of four nearest pixels thereof.

6. The method according to claim 1, wherein the step of shifting the pixels includes shifting the pixels in two dimensions.

7. The method according to claim 1, further comprising a step of selecting the test object which is designed to easily show the image shift.

8. The method according to claim 1, further comprising a step of obtaining a shift fraction of the pixels for each image and save the shift fractions for each corresponding optical path in a software.

9. A method of correcting image magnification, comprising:
aligning a center of a test object with a center of a device;
capturing a plurality of images of the test object via a plurality of optical paths of the device, wherein the images are taken by a plurality of pixels of the device;
selecting one of the images as a reference image, and the pixels taking the reference image are fixed in position; and
moving the pixels comprising each of the other images inwardly or outwardly with respect to the center of the device until each image is aligned with the reference image.

10. The method according to claim 9, further comprising a step of selecting the test object designed to easily show image magnification.

11. The method according to claim 9, wherein the pixels are move inwardly with respect to the center of the device when the corresponding image is magnified with respect to the reference image.

12. The method according to claim 9, wherein the pixels are moved outwardly with respect to the center pixel when the corresponding image is minified with respect to the reference image.

13. The method according to claim 9, further comprising a step of obtaining a magnification differential for each image with respect to the reference image.

14. The method according to claim 9, further comprising a step of obtaining a magnification differential for each image with respect to the reference image and saving the magnification differential in a software.

15. A method for measuring a signal image of an object, comprising:
capturing a plurality of images of the object by the pixels of the device via a plurality of optical paths;
correcting an image shift of each image by shifting the pixels with a corresponding shift fraction called up from a database;
correcting an image magnification of each image by moving the pixels inwardly or outwardly with respect to a center pixel thereof, the pixels being moved with a corresponding image magnification differential called up from the database; and
combining the images into the single image after the image shifts and the image magnifications thereof have been corrected.

16. The method according to claim 14, wherein step of correcting the image shift further comprising:
capturing a plurality of test images of a test object via the optical paths of the device, wherein the test images are captured by the pixels of the device;
selecting one of the test images as a reference image, and the pixels comprising the reference image are fixed in position; and
shifting the pixels comprising each of the other test images until each test image is aligned with the reference image.

17. The method according to claim 16, further comprising a step of selecting the test object designed to easily show the image shift.

18. The method according to claim 16, further comprising a step of obtaining a shift fraction for the pixels for each test image.

19. The method according to claim 15, wherein the step of correcting the image magnification further comprising:
aligning a center of a test object with a center of the device;
capturing a plurality of test images of the test object via the optical paths of the device, wherein the images are captured by the pixels of the device;
selecting one of the test images as a reference image, and the pixels taking the reference image are fixed in position; and
moving the pixels comprising each of the other test images inwardly or outwardly with respect to the center of the device until each test image is aligned with the reference image.

20. The method according to claim 19, further comprising a step of selecting the test object designed to easily show image magnification.
